(19) United States
(12) Patent Application Publication
(10) Pub. No.: US 2026/0239030 A1
(43) Pub. Date: Aug. 13, 2026

(54) OPTIMIZED POINT-TO-POINT COMMUNICATIONS SYSTEM AND METHOD

(71) Applicant: AVIONICA, LLC, Miami, FL (US)

(72) Inventors: Jeroen HOPPENBROUWERS, Miami, FL (US); Ed GORMAN, Miami, FL (US)

(73) Assignee: AVIONICA, LLC, Miami, FL (US)

(21) Appl. No.: 19/154,328

(22) PCT Filed: Feb. 7, 2024
(86) PCT No.: PCT/US2024/014833

§ 371 Date: Aug. 6, 2025

Related U.S. Application Data
(60) Provisional application No. 63/443,711, filed on Feb. 7, 2023.
(60) Provisional application No. 63/587,288, filed on Oct. 2, 2023.

(51) Int. Cl. H04W 24/02; H04L 5/00; H04W 84/06

(52) U.S. Cl. CPC H04W 24/02; H04L 5/0053; H04W 84/06

(57) ABSTRACT

The invention relates to a new and improved system and method for transmitting, receiving, and acknowledging packetized data within point-to-point communication frameworks. The system and method includes a novel predictive acknowledgement mechanism that allows for efficient and reliable confirmation of successful data transmission, while decreasing latency/transfer time. By using these techniques, the invention is a technological improvement over the current state of the art in that it can provide improved data transmission capabilities and enable new applications in air-ground communication such as increased data transfer rates, improved coverage, and reduced latency for commercial and military aviation, air traffic control, and unmanned aerial systems.

### CROSS-REFERENCE TO RELATED APPLICATIONS

The present application is a non-provisional utility patent application claiming the benefit of priority to prior filed U.S. Provisional Patent Application No. 63/443,711 filed on Feb. 7, 2023, currently pending, as well as U.S. Provisional Patent Application No. 63/587,288 filed on Oct. 2, 2023, currently pending, both of which are incorporated by reference as if fully set forth herein.

### STATEMENT REGARDING FEDERALLY SPONSORED-RESEARCH OR DEVELOPMENT

None.

### FIELD OF THE INVENTION

The present invention generally relates to communications systems, and more particularly relates to optimized systems and methods for transmitting, receiving, and acknowledging packetized data within point-to-point communications frameworks, and more specifically, in the context of air-ground communications.

### BACKGROUND

In the field of air-ground communications, transmitting, receiving, and acknowledging packetized data within point-to-point air-ground communication frameworks is a challenge due to the unique characteristics of the air-ground communication environment. Current systems (see FIG. 1) mainly rely on radio frequency (RF) technology for communication between aircraft stations and ground stations and these systems have limitations in terms of bandwidth and range. Additionally, the increasing number of aircraft and the demand for higher data rates have led to congestion and interference in the RF spectrum. Satellite communication and cellular networks also have their own limitations in terms of the speed and efficiency of data transmission, receiving, and acknowledging in the air-ground communication environment. The high mobility of aircraft, the dynamic nature of the radio frequency spectrum, and the limitations on power consumption and equipment size, makes it challenging to transmit, receive, and acknowledge packetized data efficiently.

There are several challenges and limitations in the current state of the art for air-ground communications systems, such as:

Limited bandwidth: One of the main challenges in air-ground communications is the limited bandwidth available in the radio frequency spectrum. This can lead to congestion and interference, making it difficult to transmit and receive large amounts of data.

Interference: Air-ground communications are also subject to interference from other sources, such as other aircraft and ground stations. This can make it difficult to maintain a reliable communication link.

Security: Another challenge is ensuring the security and confidentiality of the data being transmitted.

Latency: Latency is also an issue, especially in safety-critical applications, where delay in transmission and receiving of data can have severe consequences.

Compatibility: Some of the current air-ground communication systems have compatibility issues with other systems, which can make it difficult to exchange data between different types of aircraft and ground stations.

Cost: The cost of implementing and maintaining air-ground communication systems can be high, especially for small and regional airlines.

Technological Advancements: With the advent of new technologies, air-ground communications systems may become obsolete and will need to be updated to take advantage of these new technologies.

Given these challenges and limitations, there is a need for air-ground communications systems and methods that are reliable, efficient, and secure, while also being cost-effective and adaptable to new technologies.

There exists a need in the art for a viable technical and commercial solution to extend the life span of legacy communications systems, installed in thousands of aircraft.

While most widely used communications systems cannot, themselves, be modified, as many industries depend on them, there is a need to improve the communications frameworks that use those systems.

Currently, there is an urgent need in the art for an optimized system and method for transmitting, receiving, and acknowledging packetized data within point-to-point air-ground communication frameworks that overcome the limitations of existing systems, protocols, and methods.

### SUMMARY

The present invention relates to a new and improved system and method for transmitting, receiving, and acknowledging packetized data within point-to-point (air-ground) communication frameworks. Preferred embodiments of the system utilize advanced optimization techniques to improve the efficiency and reliability of data transmission and acknowledgement within the specific context of air-ground communication. Embodiments of the method include a combination of techniques such as packet fragmentation, error correction, and adaptive routing to enhance the performance of the communication system and to address the unique challenges of air-ground communication such as high-mobility and potential interference. The system and method includes a novel predictive acknowledgement mechanism that allows for efficient and reliable confirmation of successful data transmission, while decreasing latency/transfer time. By using these techniques, the invention is a technological improvement over the current state of the art in that it can provide improved data transmission capabilities and enable new applications in air-ground communication such as increased data transfer rates, improved coverage, and reduced latency for commercial and military aviation, air traffic control, and unmanned aerial systems.

In brief, a method 100 (see FIG. 2) for optimizing point-to-point communication frameworks according to an embodiment of the present invention includes the steps of:
providing 110 a processor device that is operatively communicative within a communication network having at least a first point and a second point, in bi-directional communication with the first point, and in bi-directional communication with a gateway, the gateway between the processor device and the second point;
receiving 120 by the processor device a first data packet from the first point;
transmitting 130 by the processor device said first data packet to the gateway;
receiving 140 by the processor device from the gateway a confirmation of receipt of the first data packet;
generating 150 by the processor device a predictive acknowledgment while the first data packet continues to the second point; and
transmitting 160 by the processor device of the predictive acknowledgment to the first point thereby triggering the release of any next data packet to the processor device in time to overlap with an incoming uplink acknowledgement of said first data packet,
whereby the method utilizes reliable predictive acknowledgements within the bi-directional communication network in order to improve the performance of the point-to-point communication framework.

In other embodiments, the inventive method is carried out in a system that includes hardware and software components (method steps performed by a processor device). In an exemplary embodiment of the present invention, a system 200 (see FIG. 3) is adapted for use in a point-to-point (aircraft-to-ground) communication network. An aircraft 205 is outfitted with a first point 210 that is capable of transmitting and receiving packetized data 215, such as a Communications Management Unit (CMU), computer, processor, or similar device. The aircraft is further outfitted with a processor device 220, such as a Satellite Data Unit (SDU), that is specially configured to perform the method 100 as described above. Both the first data point 210 and the processor device 220 are in bi-directional communication with each other.

On the ground 250, a gateway 260 is in bi-directional communication with the processor device 220. The bi-directional communication 230 between the ground-based gateway 260 and the processor device 220 within the aircraft 205 may be accomplished by any of a number of technologies as may be known in the art such as, but not limited to, via radio frequency (RF), cellular communication, or a one or more satellite, for example. The gateway 260 is further in bi-directional communication 240 with the second point 270 of the point-to-point communication network, for example, with a Communication/Data Service Provider (CSP/DSP).

Desired communications content, such as, but not limited to, text, voice, video, or other data, if too large to send via the then-employed protocol, is broken up into packets of data blocks that meet the requirements of the protocol. For example, some protocols have a data rate of 64 kbps that make it difficult to transmit and receive large amounts of data. To maintain an efficient system, all transmissions are broken up into short “blocks”, for example, approximately 220 bytes per block. Each block is broadcasted “blind”. Basically, the sender transmits the block, but then has to wait to receive an acknowledgement. Each block is individually acknowledged by a response block and the next block is not transmitted until the previous block is acknowledged. Longer messages are constructed by linking multiple blocks together. Un-acknowledged blocks time out and are re-sent a few more times until acknowledged.

These packetized data blocks are transferred from the first point (CMU) to the second point (CSP/DSP), and the processor device (SDU) and gateway just pass them on, unchanged. In order to prevent data packet loss or other errors due to incomplete transmission, the first point (CMU) will not release a next data packet until it receives an acknowledgement that the just sent data packet has been received at the second point (CSP/DSP) (see FIG. 4).

In the present invention, however, the framework does not need to wait for this acknowledgement from the second point (CSP/DSP) in order for the first point (CMU) to dispatch the next data packet. The processor device (SDU), upon receiving a confirmation of receipt of the data packet at the gateway (this confirmation from the gateway is normally ignored by the framework), will generate a predictive acknowledgement that mimics the acknowledgment it would later receive from the second point (CDP/DSP) and report that predictive acknowledgement to the first point (CMU), while the data packet continues down to the second point (CSP/DSP). In the system and method described the transmission and receipt of the block from the gateway to the CSP/DSP is reliable and successfully accomplished with a high level of certainty. Since all on-ground communications are reliable TCP/IP (or equivalent) links over dedicated network lines, the prediction is equally reliable.

As soon as the first point (CMU) receives this predictive acknowledgment from the processor device (SDU), the first point (CMU) then immediately hands the processor device (SDU) the next block (if any is in the queue) (see FIG. 5) at least in time to overlap with the actual uplink acknowledgment of the previous downlink block. In this way, the system combines reliable predictive acknowledgments with the bidirectionality of the system in order to significantly improve the downlink performance of the communications framework.

By way of illustration, and not limitation, using this inventive predictive acknowledgement method, the latency within the communications framework can be effectively reduced from between 15-30 seconds to about 7-15 seconds.

In other embodiments, it is desirable to avoid CMU confusion due to the presence of duplicate uplink acknowledgements. In these embodiments, the invention mitigates, or avoids altogether, technical confusion at the CMU due to the presence of the predictive acknowledgement (PreAck) alongside the real uplink acknowledgement (TechAck). This is accomplished by having the SDU suppress the duplicate, “real”, TechAck and present only the PreAck to the CMU. In systems, the delivery of the actual (“real”) acknowledgement to the SDU is utilized to keep the predictive acknowledgement active.

In further embodiments, the SDU is configured to rewrite all received uplink block identifiers (UBI) to a contiguous sequence that originates in the SDU. This is beneficial in the case of an unsolicited (payload) uplink.

Yet further embodiments provide for novel failure mode and effects analysis of the inventive system.

Embodiments of the present invention may be implemented as a computer program product stored on non-transitory storage media and run by a specially programmed processor to carry out the steps disclosed herein.

Other embodiments may be a fully hardware implementation, or a combination of hardware and software.

Other non-limiting embodiments of the present invention are contemplated and described below and include adapting the second point (CSP/DSP) software to utilize acknowledge-less downlink and uplink, as well as compressed multiblock downlink and uplink, thereby providing for a complete replacement of legacy systems.

Other embodiments of the present invention include a related system and computer program product comprising a non-transitory signal storage means for storing computer program instructions that, when executed on a processor, carry out any of the method steps disclosed and discussed herein.

The embodiments disclosed and described herein are thus described in the context of known existing air-ground communication systems. It will be acknowledged by one skilled in the art, however, that the optimizations, techniques, systems, and methods disclosed may be implemented within other similar satellite communication systems, or over cellular or other data communications systems, and not just limited to Iridium's satellite system. Furthermore, the inventive system and method may be adapted for use in other applications besides aircraft, such as, but not limited to, aerospace or nautical applications.

The invention disclosed herein includes a method, and a system within which to carry out the method steps, that is preferably adapted for and complements air-ground communications systems. The system is thus configured to provide an improvement over the current state of air-ground communications frameworks.

It is an object of the present invention to improve the speed of legacy systems.

It is one of the main objects of the present invention to provide a performance increase by just necessitating a software change to any existing aircraft-side processor device (SDU) to implement the novel downlink pre-acknowledgment method.

It is another object of this invention to provide a method adaptable to be carried out on an aircraft processor device (SDU) that uses the invention's predictive acknowledgement method to present itself as a legacy system to the first point (CMU).

It is another object of the present invention to provide an optimization of the communications framework without the need to change airborne systems, except for a software update to the processor device (SDU).

It is another object of the present invention to provide an optimization of the communications framework that is functionally invisible to the ground systems (gateway and CSP/DSP).

### BRIEF DESCRIPTION OF THE DRAWINGS

In the accompanying figures, like reference numerals refer to identical or functionally similar elements throughout the separate views. The accompanying figures, together with the detailed description below are incorporated in and form part of the specification and serve to further illustrate various embodiments and to explain various principles and advantages all in accordance with the present invention.

FIG. 1 is a simplified representation of legacy air to ground communications systems;

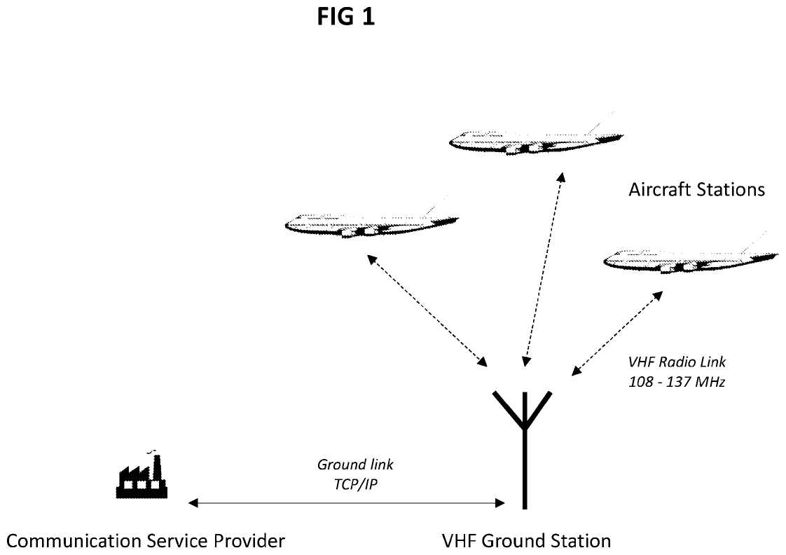

FIG. 2 is a flowchart of a method according to an embodiment of the present invention;

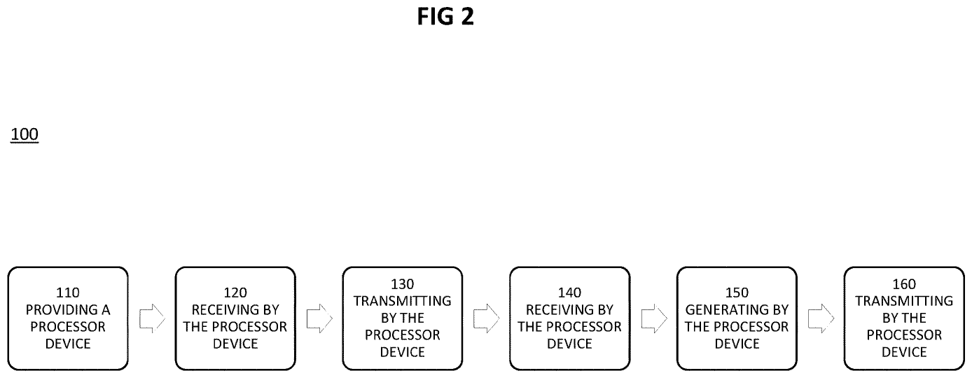

FIG. 3 is a simplified block diagram of a system according to an embodiment of the present invention;

FIG. 4 is a simplified representation of data block handling and acknowledgement in legacy systems; and

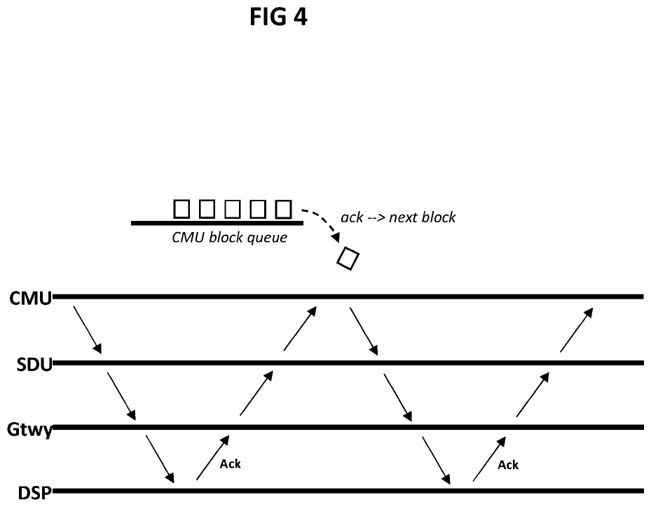

FIG. 5 is a simplified representation of improved data block handling and acknowledgement according to an embodiment of the present invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this regard, each block in a flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Though an embodiment may be disclosed as including several features, other embodiments of the invention may include fewer than all such features. Thus, for example, a claim may be directed to less than the entire set of features in a disclosed embodiment, and such claim would not include features beyond those features that the claim expressly recites.

The present disclosure is not a literal description of all embodiments of the invention(s). Also, the present disclosure is not a listing of features of the invention(s) which must be present in all embodiments.

### Non-Limiting Definitions

The title of the present application and headings of sections provided in the present application are for convenience only, and are not to be taken as limiting the disclosure in any way.

The following non-limiting definitions are provided as a guide to interpreting the present invention:

The term “product” means any machine, manufacture, and/or composition of matter, unless expressly specified otherwise. A “product” may also be a “computer program product” as disclosed herein.

The term “process” means any process, algorithm, method or the like, unless expressly specified otherwise.

Each process (whether called a method, algorithm, or otherwise) inherently includes one or more steps, and therefore all references to a “step” or “steps” of a process have an inherent antecedent basis in the mere recitation of the term “process” or a like term. Accordingly, any reference in a claim to a “step” or “steps” of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc . . . when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

A “processor” means one or more microprocessors, central processing units (CPUs), computing devices, microcontrollers, digital signal processors, or like devices or any combination thereof, regardless of the architecture (e.g., chip-level multiprocessing/multi-core, RISC, CISC, Microprocessor without Interlocked Pipeline Stages, pipelining configuration, simultaneous multithreading).

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. The term “determining” does not imply certainty or absolute precision, and therefore “determining” can include estimating, extrapolating, predicting, guessing and the like. The term “determining” does not imply that mathematical processing must be performed, and does not imply that numerical methods must be used, and does not imply that an algorithm or process is used. The term “determining” does not imply that any particular device must be used. For example, a computer need not necessarily perform the determining.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

The term “latency” is a measure of the delay in transmitting and receiving data in a communication system. In air-ground communications systems, for example, latency can be caused by a number of factors such as the distance between the aircraft and ground station, the altitude of the aircraft, and the quality of the communication link. In the case of packetized data transmission, latency can be caused by delays in receiving packet acknowledgements.

The term “packet acknowledgement”, “confirmation”, or similar term, is a message sent by the receiving device to the sending device, confirming that a packet of data has been received correctly. In the figures and throughout this disclosure an “acknowledgement” may be referred to as an “ack”.

In this disclosure and the accompanying figures, the terms “communication service provider”, “CSP”, “data service provider”, “DSP”, and equivalents, are used interchangeably and refer to the ground-based “endpoint” of the communications link between the aircraft and the ground.

As used in this disclosure, the first point, or first endpoint of the point-to-point communication network may be a Communications Management Unit (CMU), or equivalent.

As used in this disclosure, the processor device may be a Satellite Data Unit (SDU), or equivalent.

As used and discussed herein, data and communication blocks transmitted from a first point of a point-to point communication network, through the processor device, to the gateway and ultimately to the second point of a point-to-point communication network is referred to as a “downlink”. Similarly, data and communication blocks transmitted from the second point back up to the first point through the processor device, is referred to as an “uplink”. Blocks that form the “downlink” sequence are given Downlink Block Identifiers (DBI) by the first point and the first point maintains its own DBI sequence. Similarly, uplink blocks are given Uplink Block Identifiers (UBI) that form a contiguous sequence.

### Computing

It will be readily apparent to one of ordinary skill in the art that the various processes described herein may be implemented by, e.g., appropriately programmed general purpose computers, special purpose computers, and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, or one or more scripts.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices that are adapted to communicate with the computer. Any number and type of devices may be in communication with the computer.

Where a process is described, in an embodiment the process may operate without any user intervention. In another embodiment, the process includes some human intervention (e.g., a step is performed by or with the assistance of a human).

### Improving on Existing Air-Ground Communications Systems

By way of example and not limitation, the following disclosure discusses the invention in the context of a special purpose computer (such as an SDU) that is configured to run a programmed instruction set and interface with an existing air-ground communications framework via a CMU and a satellite communications network. In this way, the invention provides a technological improvement over existing air-ground communication systems.

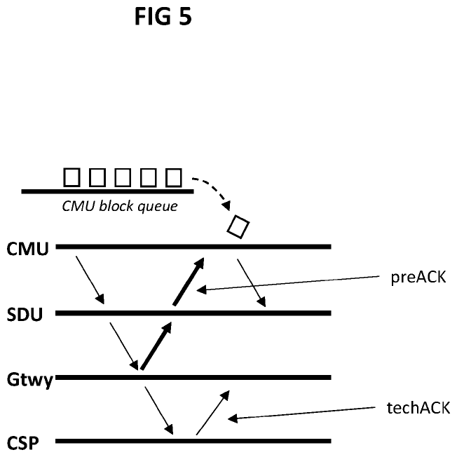

In some embodiments, a technological improvement in the field of air-ground communication is achieved by using a reliable system-generated signal as predictive acknowledgment of a down-stream event. Referring to FIG. 5, by way of example, and not limitation, a gateway receiving a data block will transmit a signal back to the SDU upon receipt of the block, even before the gateway has delivered the block to the CSP/DSP. The invention treats this signal from the gateway as a predictive acknowledgement (preACK) that the CSP/DSP will reliably receive the block at some later time. This predictive acknowledgement is reliable because the connection between the gateway and the CSP/DSP is a reliable TCP/IP link over dedicated network lines (or equivalent).

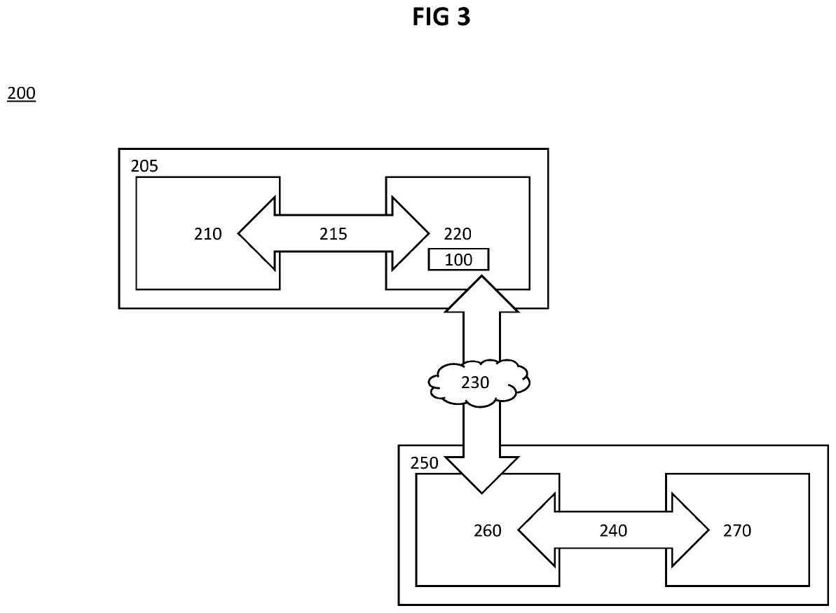

In a preferred, exemplary, embodiment, (see, for example, FIG. 3) the invention 200 is employed in the context of an aircraft 205 that includes a CMU 210 in bi-directional communication 215 with an SDU 220 that is configured to run a programmed instruction set 100 as disclosed in the embodiments, both installed onboard the aircraft 205. The SDU 220 is in bi-directional communication 230 with a satellite communication network, such as, but not limited to, Iridium SBD. The satellite communication network is, in turn, in bi-directional communication with a gateway 260. Finally, the gateway 260 is in bi-directional communication with a CSP/DSP 270 via a reliable TCP/IP link 240 (or equivalent network communication protocol) over dedicated network lines. The CMU-SDU components are considered to be the “airborne” equipment, and the gateway-CSP/DSP are the “ground” equipment.

Referring to the figures in general, and to FIG. 5, in particular, the CMU breaks “long” messages into blocks and queues them up for transmission by the SDU. The SDU is specially programmed to send the first data block to the gateway and wait for an acknowledgement of receipt at the CSP/DSP. However, upon receiving a signal from the gateway (such as, but not limited to, a “SBD Session Successful” signal) that the block has been received at the gateway (and before the block is received at the CSP/DSP), the SDU is configured to accept this signal from the gateway as a predictive acknowledgement (preACK) of the block's receipt at the CSP. This is a technological improvement to the operation of the SDU.

Since the SDU has now received a predictive acknowledgement, it will report that acknowledgment to the CMU and the CMU will immediately hand the SDU the next block in the queue (if any). Meanwhile, the previous block has continued to the CSP/DSP and the CSP/DSP has issued an actual acknowledgement (techACK) to the gateway, which then sends it on to the SDU. Being bi-directional, the crossing of downlink blocks and uplink acknowledgements is possible and provides another performance boost.

This embodiment of the present invention, implemented at the airborne SDU, is transparent to any receiving ground equipment. Since the predictive acknowledgment is performed by the SDU, then the performance improvement is driven by the SDU and the ground equipment only sees shorter times between receiving blocks.

In other embodiments, the gateway can be configured in a similar fashion as the SDU. In such an embodiment, where the gateway authenticates receipt at the CSP/DSP (and does not then wait for the CSP to send its own acknowledgement), then additional performance benefits can be realized.

In yet other embodiments of the present invention, multiblock optimization can be accomplished over the same communication framework. In some systems long messages (greater than 220 bytes) are broken up into 220 byte blocks, queued in the CMU and sent and acknowledged, one by one.

This multiblock optimization embodiment utilizes the predictive acknowledgment technique and all blocks of the multiblock message are retrieved from the CMU. This takes about one second per block. Industry standard data compression may be used to reduce the message length (max. 16×220=3520 bytes) to below 1800 bytes. For example, a 60% compression ratio is realistic on ASCII messages. The compressed message is downlinked to the gateway in one single session, which takes 10 to 15 seconds. The compressed “long block” is indicated by a different header than a normal block.

The CSP/DSP retrieves the complete message from the gateway and acknowledges it in one block. The overall transfer time of a 16-block message reduces from about 16×2×17 seconds to about 16×2 seconds. The final acknowledgement may be pre-generated by the SDU on reception of the last downlink block, or by the actual uplink acknowledgement from the CSP/DSP. Preferably, the system predictively acknowledges, as discussed above, and uses the uplink session to parallel downlink the next block.

In yet another embodiment, the invention is further configured to detect and suppress duplicate uplink acknowledgements. As discussed, the improvements in this system reside primarily in method steps embodied in software and/or hardware and performed by the SDU. There may be implementations, therefore, that involve a CMU that is not capable of receiving duplicate uplink acknowledgements. In these cases, embodiments of the invention include where the SDU is further configured to suppress the passing of the “true” uplink acknowledgement to the CMU. As discussed above, in order to reduce the acknowledgement time seen by the CMU, the SDU generates a predictive acknowledgement based upon a signal that the data block was received by the gateway. Some time later, once the CSP/DSP has actually received the data block, it issues a “real” acknowledgement (a “TechAck”) back to the gateway, which is then received by the SDU. In many cases, the SDU can just allow this “real-but-later” acknowledgement to pass on the CMU without issue. In some cases, however, it is desirable to avoid CMU “confusion”. Therefore, in some embodiments, the SDU is configured to receive the TechAck, but suppress its transmission to the CMU. In this way, the CMU does not get “confused” by receiving multiple acknowledgements for the same block. The SDU, however, can utilize this TechAck to confirm the predictive acknowledgement and to keep the predictive acknowledgement active.

A further embodiment of the present invention includes handling predictive acknowledgements when unsolicited uplinks are present. Since the unsolicited uplink block may carry a payload that includes the TechAck, the block cannot just be suppressed by the SDU, as it may be desirable to pass the TechAck to the CMU. Furthermore, as discussed above, all UBIs must be in a contiguous sequence in order to avoid CMU confusion.

In this embodiment, the SDU is further configured to reconstruct the UBI and the corresponding block check sequence checksum (BCS) into a contiguous sequence before passing any uplink blocks (either predictive acknowledgments, real acknowledgements, or other blocks or payloads) to the CMU. The result of this technological improvement over the prior art is that the CMU does not encounter any sequence anomalies due to the unsolicited uplink, nor due to the optimization performed by the SDU.

In yet further embodiments, the systems and methods of the present invention are adapted for use with any other communication link that has a built-in implicit acknowledgement, such as, but not limited to, Inmarsat, Iridium Certus, and any IP-based link technology. In all embodiments, it is central to the invention that the aircraft avionics (the CMU) does not need to be adapted, rather the SDU (and/or the gateway on the ground) is adapted to treat that built-in implicit acknowledgement as a predictive acknowledgement thereby reducing the latency time for the CMU to release the next block.

The foregoing discloses exemplary systems and methods for optimized transmitting, receiving, and acknowledging of packetized data within point-to-point communications frameworks, according to embodiments of the present invention. The system is only one example of a suitable system and is not intended to limit the scope of use or functionality of embodiments of the present invention described above. The system is operational with numerous other general purpose or special purpose computing system environments or configurations. Examples of well-known computing systems, environments, and/or configurations that may be suitable for use with the information processing system include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, clusters, and distributed cloud computing environments that include any of the above systems or devices, and the like.

The system may be described in the general context of computer-executable instructions, being executed by a computer system. The system may be practiced in various computing environments such as conventional and distributed computing environments where tasks are performed by remote processing devices that are linked through a communications network. In a distributed computing environment, program modules may be located in both local and remote computer system storage media including memory storage devices.

As will be appreciated by one skilled in the art, aspects of the present invention may be embodied as a system, method, or computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, although not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, although not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, or an interpreted, interactive, object-oriented programming language such as Python, or procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention have been discussed above with reference to flowchart illustrations and/or block diagrams of methods, apparatus (systems) and computer program products according to various embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a non-transitory computer readable storage medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The description of the present application has been presented for purposes of illustration and description but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand various embodiments of the present invention, with various modifications as are suited to the particular use contemplated.

What is claimed is:

1. A method for optimizing point-to-point communication frameworks, the method comprising:
providing a processor device that is operatively communicative within a communication network having at least a first point and a second point, in bi-directional communication with the first point, and in bi-directional communication with a gateway, the gateway between the processor device and the second point;
receiving by the processor device a first data packet from the first point;
transmitting by the processor device said first data packet to the gateway;
receiving by the processor device from the gateway a confirmation of receipt of the first data packet;
generating by the processor device a predictive acknowledgment while the first data packet continues to the second point; and
transmitting by the processor device of the predictive acknowledgment to the first point thereby triggering the release of any next data packet to the processor device in time to overlap with an incoming uplink acknowledgement of said first data packet,
whereby the method utilizes reliable predictive acknowledgements within the bi-directional communication network in order to improve the performance of the point-to-point communication framework.

2. A system for optimizing point-to-point communication frameworks, the system comprising:
a first point of the point-to-point communication framework capable of transmitting and receiving packetized data;
a second point of the point-to-point communication framework capable of transmitting and receiving packetized data;
a gateway in bidirectional communication with the second point; and
a processor device operatively coupled in bidirectional communication with the first point and the gateway, and specially configured to perform the method steps of:
receiving by the processor device a first data packet from the first point;
transmitting by the processor device said first data packet to the gateway;
receiving by the processor device from the gateway a confirmation of receipt of the first data packet;
generating by the processor device a predictive acknowledgment while the first data packet continues to the second point; and
transmitting by the processor device of the predictive acknowledgment to the first point thereby triggering the release of any next data packet to the processor device in time to overlap with an incoming uplink acknowledgement of said first data packet.
